(19) United States
(12) Patent Application Publication
(10) Pub. No.: US 2006/0120604 A1
(43) Pub. Date: Jun. 8, 2006

(54) Method and apparatus for detecting multi-view faces

(75) Inventors: Jung-bae Kim, Yongin-si (KR); Chan-min Park, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/285,172

(22) Filed: Nov. 23, 2005

(30) Foreign Application Priority Data
Dec. 7, 2004 (KR) 10-2004-0102411

(51) Int. Cl. G06K 9/00

(52) U.S. Cl. 382/181; 382/118

(57) ABSTRACT

A method and apparatus for detecting multi-view faces. The method of detecting multi-view face, includes the operations of (a) sequentially attempting to detect from an input image two mode faces among a first mode face made by up and down rotation, a second mode face made by leaning a head to the left and right, and a third mode face made by left and right rotation; (b) attempting to detect the remaining mode face that is not detected in operation (a); and (c) determining that a face is detected from the input image when the remaining mode face is detected in operation (b), wherein operation (b) comprises (b-1) arranging face detectors for all directions in parallel, when face detection succeeds in one direction, performing face detection in the same direction using a more complex face detector, and when face detection fails in one direction, performing face detection in a different direction; and (b-2) independently and separately arranging the face detectors for all directions, when face detection succeeds in one direction, performing face detection in the same direction using a more complex face detector, and when face detection fails, determining that a face is not detected from the input image.

### CROSS-REFERENCE TO RELATED APPLICATION

This application claims priority from Korean Patent Application No. 10-2004-0102411 filed on Dec. 7, 2004 in the Korean Intellectual Property Office, the disclosure of which is incorporated herein by reference.

### BACKGROUND OF THE INVENTION

1. Field of the Invention

The present invention relates to face detection, and more particularly, to a method and apparatus for detecting multi-view faces, by which any one of faces by all of X-rotation, Y-rotation, and Z-rotation is efficiently detected.

2. Description of Related Art

Face detection technology is used in various applications such as human computer interfaces and video monitoring systems, and image searching using a face as well as face recognition and has been thus increasingly important.

In particular, in digital contents management (DCM) which is technology of browsing and searching photographs and video images to allow a user to easily obtain desired information from a huge amount of multimedia data, a method of detecting and recognizing a face is essential to classify a large amount of multimedia video by individuals.

In addition, with the improvement in the performance of mobile phone cameras and the calculation performance of mobile phones, the development of user authentication technology using face recognition has been demanded for mobile phones.

Many studies have been performed on face detection for recent several years, but they concentrate on only frontal face detection. Frontal face detection is satisfactory in a limited application environment such as a face recognition system that recognizes only a frontal face using a fixed camera but is deficient to be used in a usual environment. In particular, many photographs and moving images used in image browsing and searching based on a face may be non-frontal face images. Accordingly, studies on multi-view face detection have been performed to develop technology of detecting multi-view faces including a frontal face and a non-frontal face.

Rowley et al. calculated a Z-rotation direction of a face using a router network, rotated an image so that the face positively stands, and attempted face detection using a frontal face detector to detect faces obtained by Z-rotation (hereinafter, referred to as “Z-rotation faces”) [H. Rowley, S. Baluja, and T Kanade, “Neural Network-Based Face Detection”, IEEE Trans. Pattern Analysis and Machine Intelligence, vol. 20, no. 1, pp. 23-28, Jan. 1998]. However, an error occurring in the router network is not compensated for by the face detector. As a result, a detection rate is decreased and faces obtained by X-rotation (hereinafter, referred to as “X-rotation faces”) and faces obtained by Y-rotation (hereinafter, referred to as “Y-rotation faces”) cannot be detected.

Meanwhile, Schneiderman et al. detected Y-rotation faces using three independent profile detectors [H. Schneiderman and T. Kanade, “Object Detection Using the Statistics of Parts”, Int'l J. Computer Vision, vol. 56, no. 3, pp. 151-177, February 2004]. However, this approach requires three times longer detection time than the approach using a frontal face detector and cannot detect X-rotation faces and Z-rotation faces.

Li et al. rotated an input image in three Z-axis directions and applied a detector-pyramid for detecting a Y-rotation face to each of the rotation results to simultaneously detect Y-rotation faces and Z-rotation faces [S. Z. Li and Z. Q. Zhang, “FloatBoost Learning and Statistical Face Detection”, IEEE Trans. Pattern Analysis and Machine Intelligence, vol. 26, no. 9, pp. 1112-1123, September 2004]. This approach cannot detect X-rotation faces and can only partially detect Z-rotation faces. In addition, the approach is inefficient in that the same detector-pyramid is applied to a non-face portion three times.

Jones and Viola made a Y-rotation face detector and a Z-rotation face detector separately and used one of detectors for different angles according to a result of a pose estimator calculating the direction of Y-rotation or Z-rotation [M. Jones and P. Violar, “Fast Multi-View Face Detection”, Proc. Computer Vision and Pattern Recognition, March 2003]. However, this approach cannot compensate for an error of the pose estimator like the approach of Rowley et al. and cannot detect X-rotation faces.

Although various approaches for multi-view face detection have been proposed as described above, they are limited in performance. In other words, only a part of X-rotation faces, Y-rotation faces, and Z-rotation faces can be detected or an error of a pose estimator is not compensated for. Accordingly, a solution to limitation on performance is desired.

### BRIEF SUMMARY

An aspect of the present invention provides a method and apparatus for detecting multi-view faces, by which faces obtainable from all of X-rotation, Y-rotation, and Z-rotation are detected and a pose estimator is not used before a multi-view face detector is used, thereby preventing an error of the pose estimator from occurring and performing efficient operations.

According to an aspect of the present invention, there is provided a method of detecting multi-view face, including the operations of (a) sequentially attempting to detect from an input image two mode faces among a first mode face made by up and down rotation, a second mode face made by leaning a head to the left and right, and a third mode face made by left and right rotation, (b) attempting to detect the remaining mode face that is not detected in operation (a), and (c) determining that a face is detected from the input image when the remaining mode face is detected in operation (b), wherein operation (b) comprises (b-1) arranging face detectors for all directions in parallel, when face detection succeeds in one direction, performing face detection in the same direction using a more complex face detector, and when face detection fails in one direction, performing face detection in a different direction; and (b-2) independently and separately arranging the face detectors for all directions, when face detection succeeds in one direction, performing face detection in the same direction using a more complex face detector, and when face detection fails, determining that a face is not detected from the input image.

According to another aspect of the present invention, there is provided an apparatus of detecting multi-view face having a face detection module including a subwindow generator receiving an input image and generating a subwindow with respect to the input image, a first face searcher receiving the subwindow and determining whether a whole-view face exists in the subwindow, a second face searcher sequentially searching for two mode faces among a first mode face made by up and down rotation, a second mode face made by leaning a head to the left and right, and a third mode face made by left and right rotation when the first face searcher determines that the whole-view face exists in the subwindow, a third face searcher searching for the remaining mode face that is not searched for by the second face searcher, and a controller controlling the subwindow generator to generate a new subwindow when one of the first face searcher, the second face searcher, and the third face searcher does not detect a face.

According to another aspect of the present invention, there is provided a computer-readable storage medium encoded with processing instructions for causing a processor to execute the above-described method.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 shows an example of directions in which a human face is rotated using a three-dimensional coordinate axis;

FIG. 2 shows an example of angles at which a human face is rotated around an X-axis;

FIG. 3 shows an example of angles at which a human face is rotated around a Y-axis;

FIG. 4A shows an example of angles at which a human face is rotated around a Z-axis;

FIG. 4B shows another example of angles at which a human face is rotated around the Z-axis;

FIG. 5 illustrates a procedure for reducing the number of face detectors necessary for learning in a first Z-rotation mode for a frontal-view face, according to an embodiment of the present invention;

FIG. 6 illustrates a procedure for reducing the number of face detectors necessary for learning in the first Z-rotation mode for a left-view face, according to an embodiment of the present invention;

FIG. 7 shows faces to be learned with respect to a frontal-view face in the first Z-rotation mode in an embodiment of the present invention;

FIG. 8 illustrates a procedure for reducing the number of face detectors necessary for learning in a second Z-rotation mode for a frontal-view face, according to an embodiment of the present invention;

FIG. 9 illustrates a procedure for reducing the number of face detectors necessary for learning in the second Z-rotation mode for a left-view face, according to an embodiment of the present invention;

FIG. 10 shows faces to be learned with respect to a frontal-view face in the second Z-rotation mode in an embodiment of the present invention;

FIG. 11 is a block diagram of an apparatus for detecting a face according to an embodiment of the present invention;

FIG. 12 is a block diagram of a face detection module according to the embodiment illustrated in FIG. 11;

FIGS. 13A through 13C illustrate face search methods according to an embodiment of the present invention;

FIG. 14 illustrates a method of detecting a face by combining three face search methods, according to an embodiment of the present invention;

FIGS. 15A and 15B are flowcharts of a method of detecting a face according to an embodiment of the present invention; and

FIG. 16 is a different type of flowchart of the method according to the embodiment illustrated in FIGS. 15A and 15B.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

The present invention is described hereinafter with reference to flowchart illustrations of methods according to embodiments of the invention. It is to be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

To detect multi-view faces, it is necessary to find and define face rotation angles available to people.

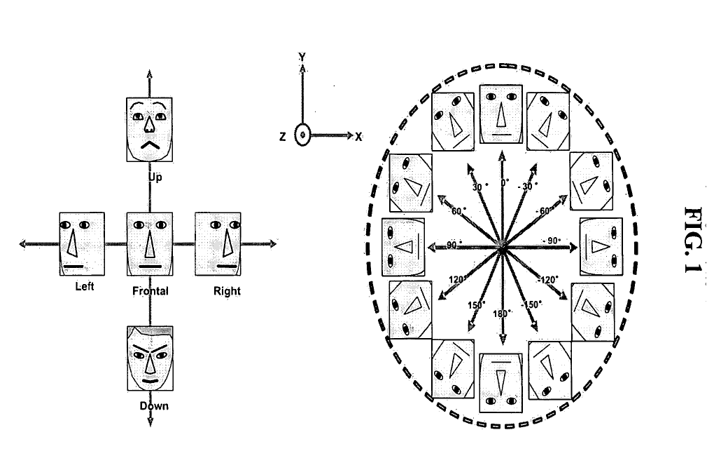

As shown in FIG. 1, a human face may be rotated around, for example, three-dimensional coordinate axes, i.e., an X-axis, a Y-axis, and a Z-axis.

When the face is rotated around the X-axis, an up-view, a frontal-view, and a down-view may be defined.

When the face is rotated around the Y-axis, a left-view, a frontal-view, and a right-view may be defined.

When the face is rotated around the Z-axis, views may be discriminated by a leaning angle. In FIG. 1, the face is leaned at intervals of 30 degrees.

Rotation angles available to people will be described with respect to each of the X-, Y-, and Z-axes.

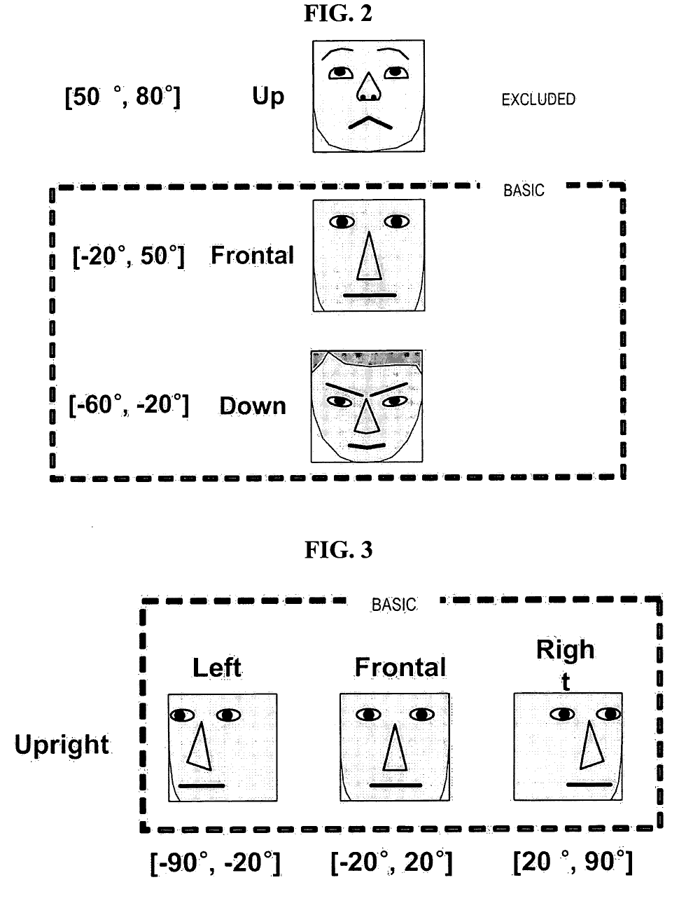

FIG. 2 shows an example of rotation angles of a human face around the X-axis. Rotation around the X-axis, i.e., X-rotation is referred to as “nodding rotation” or “out-of-plane rotation”. The X-rotation (i.e., up-and-down nodding) has a range of about [−60°, 80°]. However, an up-view face in a range of [20°, 50°] has a high occurrence frequency and can be detected using a method of detecting a frontal-view face. An up-view face in a range of [50°, 80°] rarely occurs and does not show face elements well and may be thus excluded from detection. Preferably, with respect to the X-rotation, only a down-view face in a range of [−60°, −20°] and a frontal-view face in a range of [−20°, 50°] are detected.

FIG. 3 shows an example of rotation angles of a human face around the Y-axis. Rotation around the Y-axis, i.e., Y-rotation is referred to as “out-of-plane rotation”.

The Y-rotation (left and right rotation) has a range of [−180°, 180°]. However, in a range of [180°, −90°] and a range of [90°, 180°], the back of a head occupies more than a face. Accordingly, in an embodiment of the present invention, only a left-view face in a range of [−90°, −20°], a frontal-view face in a range of [−20°, 20°], and a right-view face in a range of [20°, 90°] are detected with respect to the Y-rotation.

When a face is rotated around the Z-axis, Z-rotation (left and right leaning) has a range of [−180°, 180°]. The Z-rotation is referred to as “in-plane rotation”.

With respect to Z-rotation, all rotation in the range of [−180°, 180°] are dealt. However, people can lean the face only in a range of [−45°, 45°] when standing. Accordingly, detection is performed with respect to rotation in the range of [−45°, 45°] in a basic mode and is performed with respect to rotation in the range of [−180°, 180°] in an extension mode.

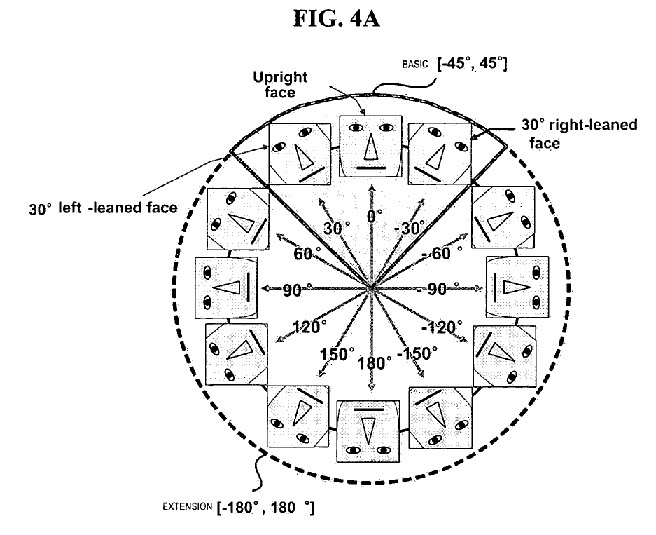

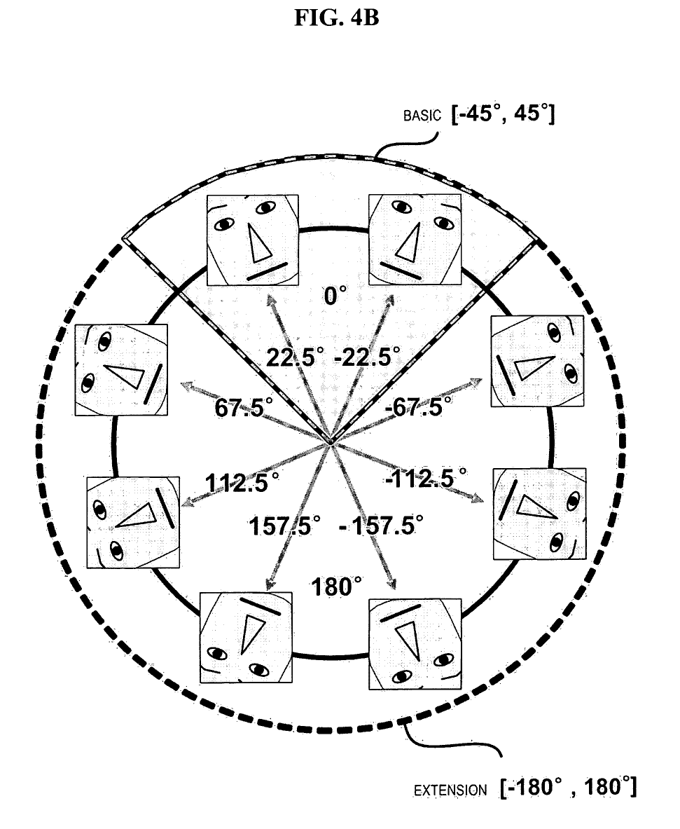

In addition, with respect to the Z-rotation, a face may be defined to lean at intervals of 30° and 45°, which is respectively illustrated in FIGS. 4A and 4B. Hereinafter, a mode illustrated in FIG. 4A is referred to as a first Z-rotation mode and a mode illustrated in FIG. 4B is referred to as a second Z-rotation mode. In the Z-rotation, a left-leaned face, an upright face, and a right-leaned face are defined.

Table 1 shows the ranges of rotation angles of a face to be detected according to an embodiment of the present invention.

TABLE 1

| | | Division | | |
|---|---|---|---|---|
| | | X-rotation | Y-rotation | Z-rotation |
| Description | | Up-and-down | Left and right | Left and right |
| | | nodding | rotation | leaning |
| Rotatable angle | | [−60°, 80°] | [−180°, 180°] | [−180°, 180°] |
| Detec- | Basic | [−60°, 50°] | [−90°, 90°] | [−45°, 45°] |
| tion | mode | | | |
| target | Extension | [−60°, 50°] | [−90°, 90°] | [−180°, 180°] |
| | mode | | | |

Meanwhile, a face detection apparatus according to an embodiment of the present invention may detect a face using cascaded classifiers, each of which is trained with conventional appearance-based pattern recognition, i.e., an AdaBoost algorithm. The AdaBoost algorithm is an efficient learning algorithm that configures a plurality of simple and fast weak classifiers in a form of a weighted sum, thereby producing a single strong classifier which is fast and has a high success rate. Hereinafter, a strong classifier for detecting a particular face pose is referred to as a “face detector”.

The face detector discriminates a face from a non-face in an input image using a plurality of face patterns that it has learned. Accordingly, it is necessary to determine face patterns to be learned.

As described above, to detect a down-view face in the range of [−60°, −20°] and a frontal-view face in the range of [−20°, 50°] with respect to the X-rotation, two face detectors are needed.

In addition, to detect a left-view face in the range of [−90°, −20°], a frontal-view face in the range of [−20°, 20°], and a right-view face in the range of [20°, 90°] with respect to the Y-rotation, three face detectors are needed.

In the first Z-rotation mode, 12 face detectors are needed in the extension mode and three face detectors are needed in the basic mode. In the second Z-rotation mode, 8 face detectors are needed in the extension mode and two face detectors are needed in the basic mode.

Consequently, when all of the X-, Y-, and Z-rotations are considered in the first X-rotation mode, 2×3×3=18 face detectors are needed in the basic mode and 2×3×12=72 face detectors are needed in the extension mode.

When all of the X-, Y-, and Z-rotations are considered in the second X-rotation mode, 2×3×2=12 face detectors are needed in the basic mode and 2×3×8=48 face detectors are needed in the extension mode.

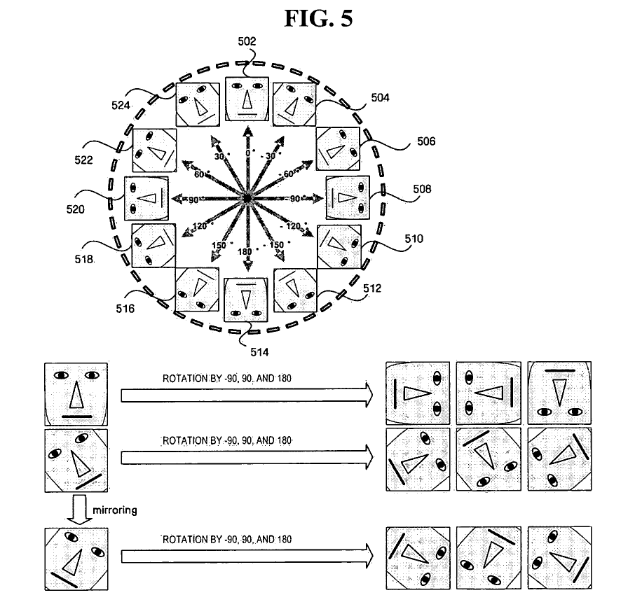

However, in the first and second Z-rotation modes, the number of face detectors for learning can be reduced by using rotation or mirroring (changing left and right coordinates), which is illustrated in FIG. 5.

For example, with respect to a frontal-view face in the first Z-rotation mode, when an upright face 502 is rotated by −90°, 90°, and 180°, face images 508, 520, and 514 are obtained. When a 30° left-leaned face 524 is rotated by −90°, 90°, and 180°, face images 506, 518, and 512 are obtained. In addition, when the 30° left-leaned face 524 is mirrored, a 30° right-leaned face 504 is obtained. When the 30° right-leaned face 504 is rotated by −90°, 90°, and 180°, face images 510, 522, and 516 are obtained. As a result, since faces other than the upright face 502 and the 30° left-leaned face 524 can be obtained through rotation or mirroring, 12 face detectors for a frontal-view face can be made by learning two face detectors.

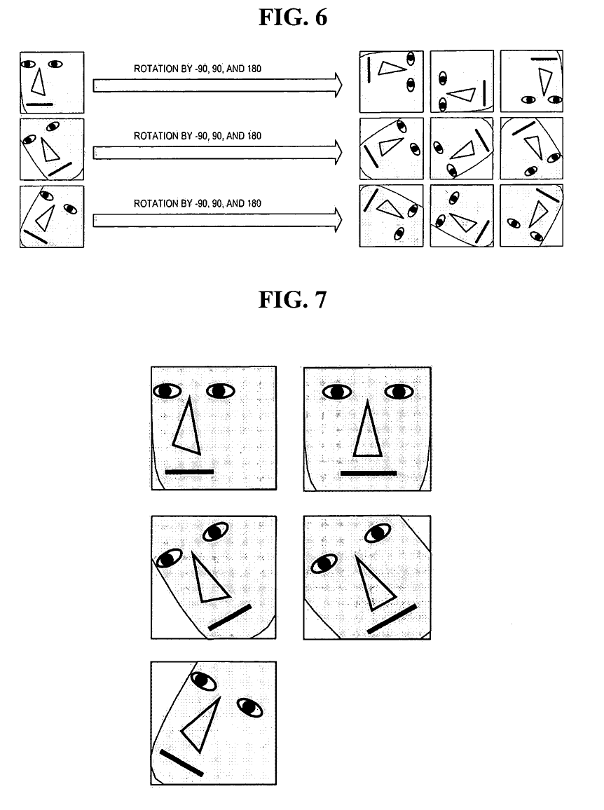

In the same manner, as shown in FIG. 6, 12 face detectors can be made using three face detectors with respect to a left-view face. In addition, a right-view face can be obtained by mirroring the left-view face.

Consequently, when all of the X-, Y-, and Z-rotations are considered in the first X-rotation mode, 2 (a frontal-view and a down-view)ₓ5=10 face detectors are needed to be learned in the basic and extension modes. Here, faces to be learned with respect to the frontal-view face are shown in FIG. 7.

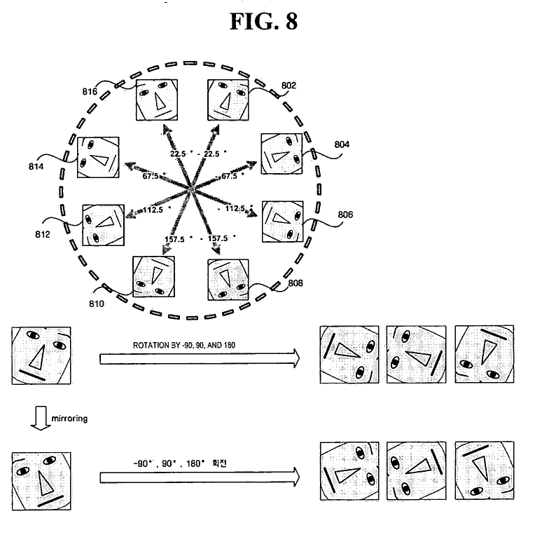

Referring to FIG. 8, with respect to a frontal-view face in the second Z-rotation mode, when a right-leaned face 802 in the basic mode is rotated by −90°, 90°, and 180°, face images 806, 814, and 810 are obtained. When the right-leaned face 802 is mirrored, a left-leaned face 816 is obtained. When the left-leaned face 816 is rotated by −90°, 90°, and 180°, face images 804, 812, and 808 are obtained. Consequently, when only the right-leaned face 802 is learned, other faces can be obtained through rotation or mirroring. Accordingly, 8 face detectors for the frontal-view face can be made by learning only a single face detector.

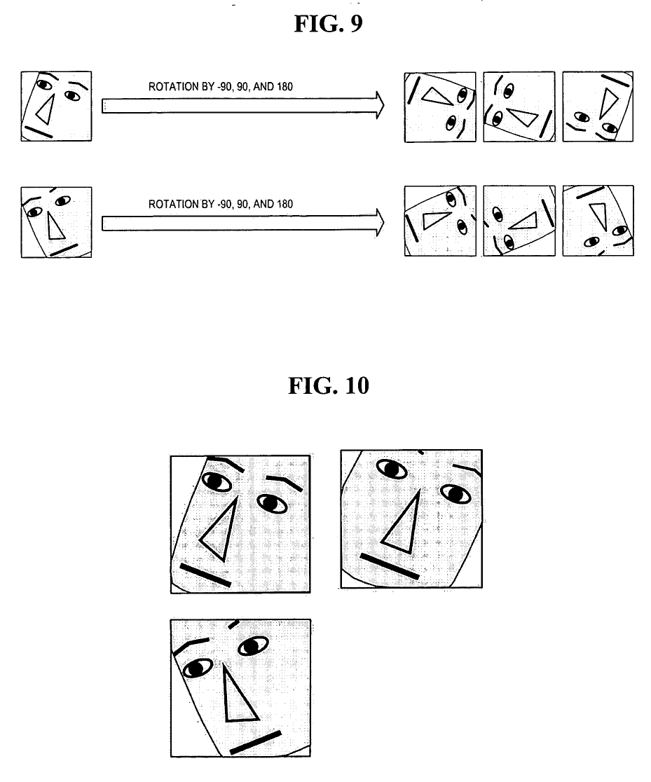

In the same manner, referring to FIG. 9, 8 face detectors can be made using two face detectors with respect to a left-view face. In addition, a right-view face can be obtained by mirroring the left-view face.

Consequently, when all of the X-, Y-, and Z-rotations are considered in the second Z-rotation mode, 2 (a frontal-view and a down-view)ₓ3=6 face detectors are needed to learn in the basic and extension modes. Here, faces to be learned with respect to the frontal-view face are shown in FIG. 10.

Table 2 shows the number of face detectors needed in an embodiment of the present invention.

TABLE 2

| | | Number of | Number of |
|---|---|---|---|
| | | necessary face | face detectors |
| | | detectors | to learn |
| First mode | Basic mode | 18 | 10 |
| | Extension mode | 72 | 10 |
| Second mode | Basic mode | 12 | 6 |
| | Extension mode | 48 | 6 |

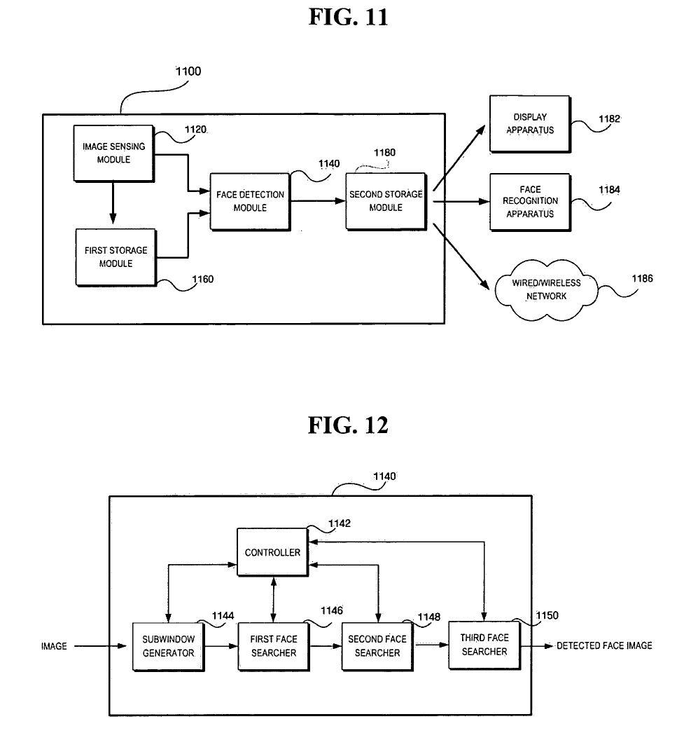

FIG. 11 is a block diagram of a face detection apparatus 1100 according to an embodiment of the present invention. The face detection apparatus 1100 includes an image sensing module 1120, a face detection module 1140, a first storage module 1160, and a second storage module 1180.

The image sensing module 1120 has an imaging function like a camera. The image sensing module 1120 senses an image of an object and provides the image to the face detection module 1140.

The first storage module 1160 stores images sensed by the image sensing module 1120 or images captured by a user and provides the stored images to the face detection module 1140 according to the user's request.

The face detection module 1140 detects a human face from an image received from the image sensing module 1120 or the first storage module 1160.

The second storage module 1180 stores an image of the detected human face. The image stored in the second storage module 1180 may be transmitted to a display apparatus 1182, a face recognition apparatus 1184, or other image processing apparatus through a wired/wireless network 1186.

The first storage module 1160 and the second storage module 1180 may be implemented as different storage areas in a physically single storage medium or may be implemented as different storage media, respectively.

In addition, the storage areas for the respective first and second storage modules 1160 and 1180 may be defined by a software program.

The term “module,” as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

FIG. 12 is a block diagram of an example of the face detection module 1140 illustrated in FIG. 11. The face detection module 1140 includes a controller 1142, a subwindow generator 1144, a first face searcher 1146, a second face searcher 1148, and a third face searcher 1150.

The subwindow generator 1144 generates a subwindow for an input image received from the image sensing module 1120 or the first storage module 1160. The subwindow is a portion clipped out of the input image in a predetermined size. For example, when the input image has a size of 320×240 pixels, if an image of 24×24 pixels is clipped, the clipped image will be a subwindow of the input image. Here, the subwindow generator 1144 defines a minimum subwindow size and increases the length or width of a subwindow step by step starting from the minimum subwindow size. In other words, the subwindow generator 1144 sequentially provides the first face searcher 1146 with subwindows generated while increasing the size of the subwindow step by step.

The first face searcher 1146, the second face searcher 1148, and the third face searcher 1150 perform operations to detect a face from each subwindow generated by the subwindow generator 1144.

The controller 1142 controls the operation of the subwindow generator 1144 according to whether a face is detected by the operations of the first through third face searchers 1146 through 1150.

Upon receiving a subwindow from the subwindow generator 1144, the first face searcher 1146 searches for a face in the subwindow using a predetermined algorithm. If a face is detected, the first face searcher 1146 transmits the subwindow to the second face searcher 1148. However, if no face is detected, the controller 1142 controls the subwindow generator 1144 to generate and transmit a new subwindow to the first face searcher 1146. The second face searcher 1148 searches for a face in the received subwindow using a predetermined algorithm. If a face is detected, the second face searcher 1148 transmits the subwindow to the third face searcher 1150. However, if no face is detected, the controller 1142 controls the subwindow generator 1144 to generate and transmit a new subwindow to the first face searcher 1146. The third face searcher 1150 searches for a face in the received subwindow using a predetermined algorithm. If a face is detected, the third face searcher 1150 stores the subwindow in a separate storage area (not shown). After face search is completely performed on all subwindows of the image provided by the image sensing module 1120 or the first storage module 1160, face detection information of the image is stored in the second storage module 1180 based on the stored subwindows. However, if no face is detected by the third face searcher 1150, the controller 1142 controls the subwindow generator 1144 to generate and transmit a new subwindow to the first face searcher 1146.

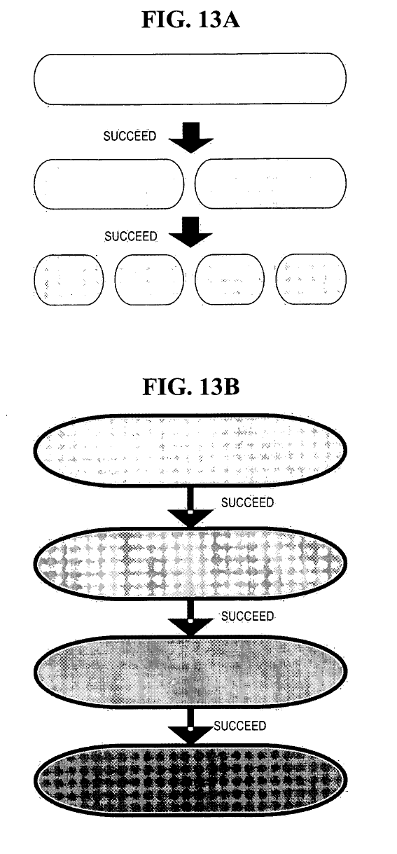

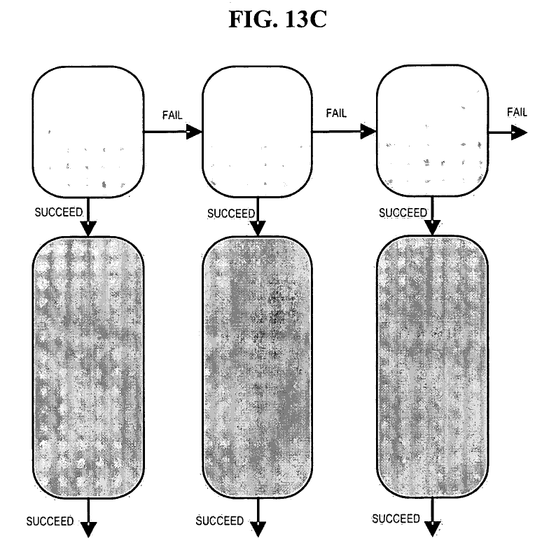

The algorithms respectively used by the first face searcher 1146, the second face searcher 1148, and the third face searcher 1150 to search for a face will be described with reference to FIGS. 13A through 13C.

FIG. 13A illustrates a conventional coarse-to-fine search algorithm, FIG. 13B illustrates a conventional simple-to-complex search algorithm, and FIG. 13C illustrates a parallel-to-separated search algorithm according to an embodiment of the present invention.

In the coarse-to-fine search algorithm, a whole-view classifier is made at an initial stage of a cascaded classifier and then classifiers for gradually narrower angles are made. When the coarse-to-fine search algorithm is used, a non-face is quickly removed in early stages so that entire detection time can be reduced. The whole-view classifier only searches for the shape of a face in a given subwindow using information that has been learned, regardless of the pose of the face.

In the simple-to-complex search algorithm, an easy and simple classifier is disposed at an earlier stage and a difficult and complex classifier is disposed at a latter stage to increase speed. Since most of non-faces are removed in an initial stage, a great effect can be achieved when the initial stage is made simple.

In the parallel-to-separated search algorithm according to an embodiment of the present invention, face detectors for all directions are arranged in parallel up to, for example, K-th stages, and face detectors for respective different directions are independently and separately arranged starting from a (K+1)-th stage. In the parallel arrangement, when face detection succeeds in one direction, a subsequent stage in the same direction is continued. However, when face detection fails in one direction, face detection is performed in a different direction. In the separated arrangement, when face detection in one direction succeeds, a subsequent stage in the same direction is continued. However, when face detection fails, a non-face is immediately determined and the face detection is terminated. When the parallel-to-separated search algorithm is used, the direction of a face in an input image is determined in an initial stage, and thereafter, a face or a non-face is determined only with respect to the direction. Accordingly, a face detector having high accuracy and fast speed can be implemented.

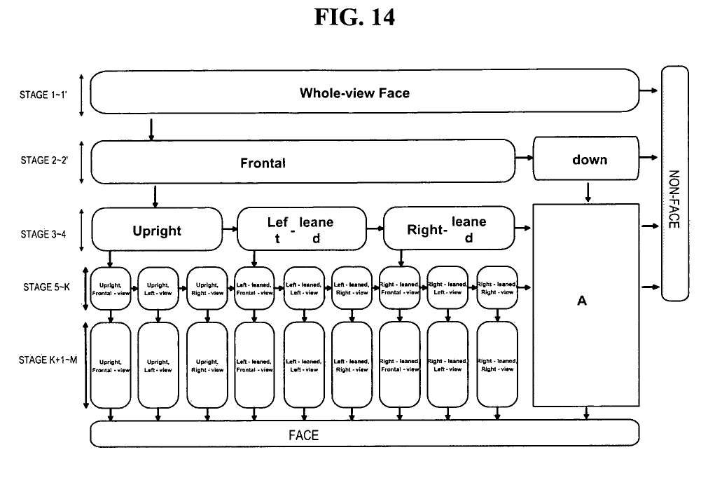

When the algorithms illustrated in FIGS. 13A through 13C are combined, a multi-view face detector illustrated in FIG. 14 can be made.

In FIG. 14, each block is a face detector detecting a face in a direction written in the block. An area denoted by “A” operates in the same manner as the left part, and thus a description thereof is omitted. A downward arrow indicates a flow of the operation when a face detector succeeds in detecting a face. A rightward arrow indicates a flow of the operation when a face detector fails in detecting a face.

For example, referring to FIGS. 12 and 14, upon receiving a subwindow from the subwindow generator 1144, the first face searcher 1146 discriminates a face from a non-face using a whole-view face detector based on already learned information in stage 1˜1′.

When a face is determined in stage 1˜1′, the first face searcher 1146 transmits the subwindow to the second face searcher 1148. The second face searcher 1148 performs stage 2˜2′ and stage 3˜4.

In stage 2˜2′, a frontal-view face and a down-view face are grouped with respect to the X-rotation and face detection is performed based on the already learned information. In stage 3˜4, an upright face, a left-leaned face, and a right-leaned face are grouped with respect to the Z-rotation and face detection is performed based on the already learned information.

Stage 1˜1′, stage 2˜2′, and stage 3˜4 are performed using the coarse-to-fine search algorithm. Face detectors performing stage 1˜1′, stage 2˜2′, and stage 3˜4 internally use the simple-to-complex search algorithm.

Up to stage M, faces in all directions are classified based on the already learned information. Here, up to stage K, when face detection succeeds, a subsequent downward stage is performed and when face detection fails, the operation shifts to a right face detector. After stage K, when face detection succeeds, a subsequent downward stage is performed, but when face detection fails, a non-face is determined and face detection on a current subwindow is terminated. Accordingly, only with respect to a subwindow reaching stage M, it is determined that a face is detected.

Stage 5˜K and stage K+1˜M are performed using the parallel-to-separated search algorithm. In addition, face detectors performing stage 5˜K and stage K+1˜M internally use the simple-to-complex search algorithm.

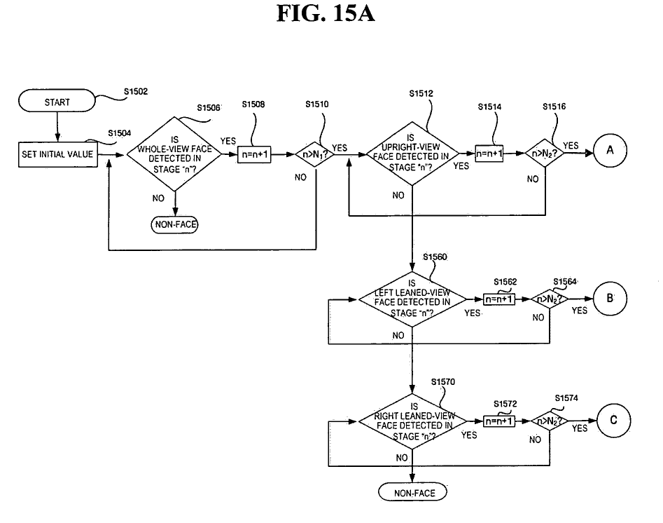

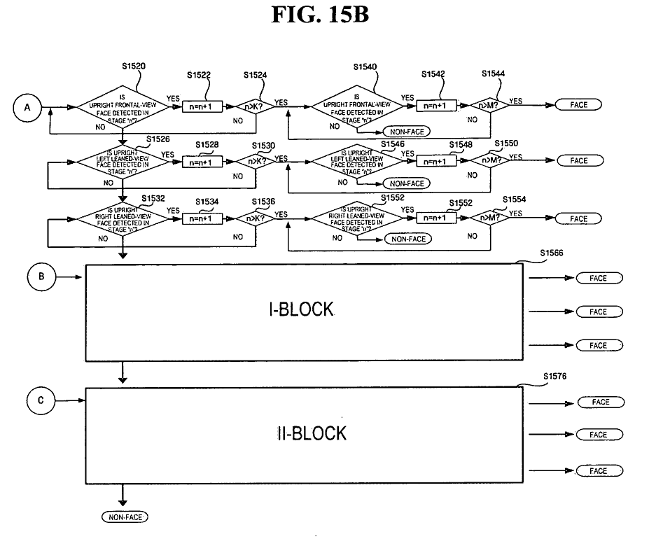

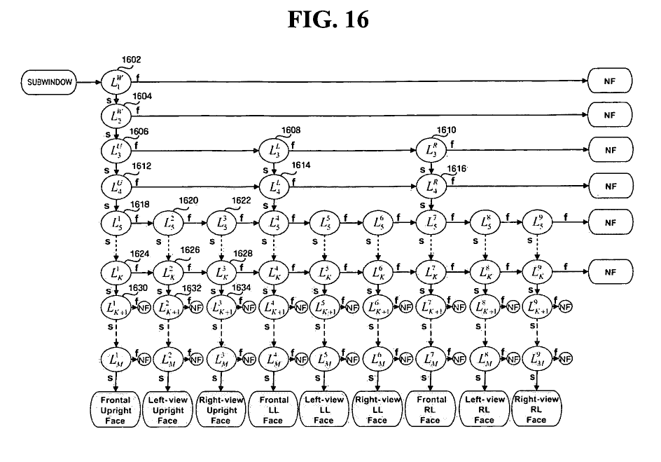

FIGS. 15A and 15B are flowcharts of a method of detecting a face according to an embodiment of the present invention. FIG. 16 is a different type of flowchart of the method according to the embodiment illustrated in FIGS. 15A and 15B.

The method of detecting a face according to an embodiment of the present invention will be described with reference to FIGS. 11, 12, and 15A through 16. Here, it is assumed that an image provided by the image sensing module 1120 or the first storage module 1160 is a frontal-view face defined with respect to the X-rotation. Accordingly, stage 2˜2′ shown in FIG. 14 is omitted, and a stage for detecting a whole-view face is referred to as stage 1˜2. In FIG. 6, W represents “whole-view”, U represents “upright”, L represents “30° left-leaned”, R represents “30° right-leaned”, “f” represents “fail” indicating that face detection has failed, “s” represents “succeed” indicating that face detection has succeeded, and NF represents “non-face”.

When the subwindow generator 1144 generates a subwindow in operation S1502, an initial value for detecting a face in the subwindow is set in operation S1504. The initial value includes parameters n, N₁, N₂, K, and M.

The parameter “n” indicates a stage in the face detection. The parameter N₁ indicates a reference value for searching for a whole-view face. The parameter N₂ indicates a reference value for searching for an upright-view face, a left leaned-view face, and a right leaned-view face defined with respect to the Z-rotation. The parameter M indicates a reference value for searching for a frontal-view face, a left-view face, and a right-view face defined with respect to the Y-rotation. The parameter K indicates a reference value for discriminating a stage for arranging face detectors separately from a stage for arranging face detectors in parallel in the parallel-to-separated search algorithm according to an embodiment of the present invention. Here, the initial value is set such that n=1, N₁=2, N₂=4, K=10, and M=25.

After the initial value is set, the first face searcher 1146 searches for a whole-view face in stage “n” in operation S1506, i.e., 1602. If a whole-view face is not detected, it is determined that no face exists in the subwindow. If a whole-view face is detected, the parameter “n” is increased by 1 in operation S1508. It is determined whether the value of “n” is greater than the value of N₁ in operation S1510. If the value of “n” is not greater than the value of N₁, the method goes back to operation S1506. Since the parameter N₁ is set to 2 in the embodiment of the present invention, the first face searcher 1146 performs the simple-to-complex search algorithm on the whole-view face two times (1602→1604).

If it is determined that the value of “n” is greater than the value of N₁ in operation S1510, the second face searcher 1148 searches for an upright-view face in stage “n” in operation S1512 (i.e., 1606). Here, the coarse-to-fine search algorithm is used.

If the upright-view face is not detected in operation S1512 (i.e., 1606), a left leaned-view face is searched for in the same stage “n” in operation S1560 (i.e., 1608). If the left leaned-view face is not detected in operation S1560, a right leaned-view face is searched for in the same stage “n” in operation S1570 (i.e., 1610). If the right leaned-view face is not detected in operation S1570, it is determined that no face exists in the current subwindow. If a face is detected in operation S1512 (1606), S1560 (1608), or S1570 (1610), the value of “n” is increased by 1 in operation S1514, S1562, or S1572, respectively, and it is determined whether the increased value of “n” is greater than the value of N₂ in operation S1516, S1564, or S1574, respectively. If the value of “n” is not greater than the value of N₂, the method goes back to operation S1512, S1560, or S1570. Since the value of N₂ is set to 4 in the embodiment of the present invention, the second face searcher 1148 performs the simple-to-complex search algorithm on the upright-view face, the left leaned-view face, or the right leaned-view face two times (1606→1612, 1608→1614, or 1610→1616).

Hereinafter, for clarity of the description, it is assumed that a face is detected in operation S1512 and the value of “n” is greater than the value of N₂ in operation S1516. Referring to FIG. 15B, the same operations as operations S1520 through S1554 are performed in an 1-block (S1566) and an 11-block (S1576).

The third face searcher 1150 searches for an upright frontal-view face in stage “n” in operation S1520 (i.e., 1618). If the upright frontal-view face is not detected in operation S1520 (1618), an upright left leaned-view face is detected in the same stage “n” in operation S1526 (i.e., 1620). If the upright left leaned-view face is not detected in operation S1526, an upright right leaned-view face is searched for in the same stage “n” in operation S1532 (i.e., 1622). If the upright right leaned-view face is not detected in operation S1532, face detection is continued in the 1-block (S1566) or the 11-block (S1576).

If a face is detected in operation S1520 (1618), S1526 (S1620), or S1532 (1622), the value of “n” is increased by 1 in operation S1522, S1528, or S1534, respectively, and it is determined whether the increased value of “n” is greater than the value of K in operation S1524, S1530, or S1535, respectively. If the value of “n” is not greater than the value of K, the method goes back to operation S1520, S1526, or S1532. Since the value of K is set to 10 in the embodiment of the present invention, the third face searcher 1150 performs the simple-to-complex search algorithm on the upright frontal-view face, the upright left leaned-view face, or the upright right leaned-view face up to a maximum of 6 times (1618→1624, 1620→1626, or 1622→1628).

Hereinafter, for clarity of the description, it is assumed that the upright frontal-view face is detected in operation S1520 and it is determined that the value of “n” is greater than the value of K in operation S1524.

The third face searcher 1150 searches for an upright frontal-view face in stage “n” in operation S1540 (i.e., 1630). If the upright frontal-view face is not detected in operation S1540 (1630), it is determined that no face exists in the current subwindow. If the upright frontal-view face is detected in operation S1540, the value of “n” is increased by 1 in operation S1542 and it is determined whether the increased value of “n” is greater than the value of M in operation S1544. If the increased value of “n” is not greater than the value of M, the method goes back to operation S1540. If the increased value of “n” is greater than the value of M, it is determined that a face exists in the current subwindow.

As described above, the third face searcher 1150 operates using the parallel-to-separated search algorithm according to an embodiment of the present invention and the conventional simple-to-complex search algorithm. In other words, face detectors for all directions are arranged in parallel up to stage K and are arranged separately from each other from stage K+1 to stage M, and the simple-to-complex search algorithm is used when a stage shifts.

Meanwhile, in an embodiment of the present invention, X-rotation faces are detected first, Z-rotation faces are detected next, and Y-rotation faces are detected finally. However, such order is just an example, and it will be obvious to those skilled in the art that the order may be changed in face detection.

According to the above-described embodiments of the present invention, any one of the X-rotation faces, Y-rotation faces and Z-rotation faces can be detected. In addition, since a pose estimator is not used prior to a multi-view face detector, an error of the pose estimator does not occur and accuracy and operating speed increase. As a result, an efficient operation can be performed.

The above-described embodiments of the present invention can be used for any field requiring face recognition such as credit cards, cash cards, digital social security cards, cards needing identity authentication, terminal access control, control systems in public places, digital album, and recognition of photographs of criminals. The present invention can also be used for security monitoring systems.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of detecting a multi-view face, comprising:
sequentially attempting to detect from an input image two mode faces among a first mode face made by up and down rotation of a face, a second mode face made by leaning a head to the left and right, and a third mode face made by left and right rotation of the face;
attempting to detect the remaining mode face that is not detected in the sequentially attempting; and
determining that a face is detected from the input image when the remaining mode face is detected in the attempting to detect the remaining mode,
wherein the attempting to detect the remaining mode comprises:
arranging face detectors for detectable directions in parallel and performing face detection; and
independently and separately arranging the face detectors for the detectable directions and performing face detection.

2. The method of claim 1, wherein the arranging face detectors comprises:
arranging the face detectors for the detectable directions in parallel;
performing face detection in the same direction using a more complex face detector when face detection succeeds in one direction; and
performing face detection in a different direction when face detection fails in one direction.

3. The method of claim 1, wherein the independently and separately arranging comprises:
independently and separately arranging the face detectors for the detectable directions;
performing face detection in the same direction using a more complex face detector when face detection succeeds in one direction; and
determining that a face is not detected from the input image when face detection fails.

4. The method of claim 1, wherein, in the sequentially attempting, sequential detection of the two mode faces is attempted using a coarse-to-fine search algorithm.

5. The method of claim 1, wherein in the sequentially attempting, detection of one of the two mode faces is attempted using a simple-to-complex search algorithm.

6. The method of claim 1, wherein the first mode face comprises a down-view face in a range of [−60°, −20°] around an X-axis and a frontal-view face in a range of [−20°, 50°] around the X-axis.

7. The method of claim 1, wherein the second mode face comprises an upright face and a leaned face made by rotating the upright face by −30° or 30° around a Z-axis in a range of [−45°, 45°] around the Z-axis and comprises the upright face, the leaned face, and other leaned faces obtained using the upright face and the leaned face in a range of [−180°, 180°] around the Z-axis.

8. The method of claim 1, wherein the second mode face comprises two leaned faces having a rotation angle of 45° therebetween in a range of [−45°, 45°] around a Z-axis and comprises the two leaned face and other leaned faces obtained using the two leaned faces in a range of [−180°, 180°] around the Z-axis.

9. The method of claim 1, wherein the third mode face comprises a left-view face in a range of [−90°, −20°] around a Y-axis, a frontal-view face in a range of [−20°, 20°] around the Y-axis, and a right-view face in a range of [20°, 90°] around the Y-axis.

10. An apparatus of detecting a multi-view face, including a face detection module, the module comprising:
a subwindow generator receiving an input image and generating a subwindow with respect to the input image;
a first face searcher receiving the subwindow and determining whether a whole-view face exists in the subwindow;
a second face searcher sequentially searching for two mode faces among a first mode face made by up and down rotation of a face, a second mode face made by leaning a head to the left and right, and a third mode face made by left and right rotation of the face when the first face searcher determines that the whole-view face exists in the subwindow;
a third face searcher searching for the remaining mode face that is not searched for by the second face searcher; and
a controller controlling the subwindow generator to generate a new subwindow when one of the first face searcher, the second face searcher, and the third face searcher does not detect a face.

11. The apparatus of claim 10, further comprising an image sensing module sensing an image of an object, wherein the input image received by the subwindow generator is the image received from the image sensing module.

12. The apparatus of claim 10, further comprising a storage module storing an image captured by a user, wherein the input image received by the subwindow generator is the image received from the storage module.

13. The apparatus of claim 10, further comprising a storage module storing a face image detected by the face detection module.

14. The apparatus of claim 10, wherein the third face searcher sequentially performs:
an operation of arranging face detectors for all directions in parallel when succeeding in face detection in one direction, performing face detection in the same direction using a more complex face detector, and performing face detection in a different direction when failing in face detection in one direction; and
an operation of independently and separately arranging the face detectors for all directions when succeeding in face detection in one direction, performing face detection in the same direction using a more complex face detector, and determining that a face is not detected from the input image when failing in face detection.

15. The apparatus of claim 10, wherein the first face searcher performs sequential detection of the two mode faces using a coarse-to-fine search algorithm.

16. The apparatus of claim 10, wherein the second face searcher performs detection of one of the two mode faces using a simple-to-complex search algorithm.

17. The apparatus of claim 10, wherein the first mode face comprises a down-view face in a range of [−60°, −20°] around an X-axis and a frontal-view face in a range of [−20°, 50°] around the X-axis.

18. The apparatus of claim 10, wherein the second mode face comprises an upright face and a leaned face made by rotating the upright face by −30° or 30° around a Z-axis in a range of [−45°, 45°] around the Z-axis and comprises the upright face, the leaned face, and other leaned faces obtained using the upright face and the leaned face in a range of [−180°, 180°] around the Z-axis.

19. The apparatus of claim 10, wherein the second mode face comprises two leaned faces having a rotation angle of 45° therebetween in a range of [−45°, 45°] around a Z-axis and comprises the two leaned face and other leaned faces obtained using the two leaned faces in a range of [−180°, 180°] around the Z-axis.

20. The apparatus of claim 10, wherein the third mode face comprises a left-view face in a range of [−90°, −20°] around a Y-axis, a frontal-view face in a range of [−20°, 20°] around the Y-axis, and a right-view face in a range of [20°, 90°] around the Y-axis.

21. The apparatus of claim 10, wherein the first, second, or third face searcher used uses cascaded classifiers, each of which is trained with an appearance-based pattern recognition algorithms.

22. A computer-readable storage medium encoded with processing instructions for causing a processor to execute a method of detecting a multi-view face, comprising:
sequentially attempting to detect from an input image two mode faces among a first mode face made by up and down rotation of a face, a second mode face made by leaning a head to the left and right, and a third mode face made by left and right rotation of the face;
attempting to detect the remaining mode face that is not detected in the sequentially attempting; and
determining that a face is detected from the input image when the remaining mode face is detected in the attempting to detect the remaining mode,
wherein the attempting to detect the remaining mode comprises:
arranging face detectors for detectable directions in parallel and performing face detection; and
independently and separately arranging the face detectors for the detectable directions and performing face detection.
